(19) United States
(12) Patent Application Publication
(10) Pub. No.: US 2012/0109569 A1
(43) Pub. Date: May 3, 2012

(54) DIAGNOSIS OF BEARING THERMAL ANOMALIES IN AN ELECTRICAL MACHINE

(75) Inventors: Dileep Kumar Kana Padinharu, Bangalore (IN); Vinodh Kumar Bandaru, Bangalore (IN); Vasudev Shankar Nilajkar, Bangalore (IN)

(73) Assignee: GENERAL ELECTRIC COMPANY, Schenectady, NY (US)

(21) Appl. No.: 12/913,188

(22) Filed: Oct. 27, 2010

(51) Int. Cl. G06F 15/00

(52) U.S. Cl. 702/130; 702/182

(57) ABSTRACT

A system for evaluating bearing metal temperature (BMT) to diagnose rotor misalignment and/or bearing wipe in an electrical machine. A first system is provided that includes: an input system for obtaining bearing metal temperature (BMT) readings from a first BMT sensor located proximate the turbine and a second BMT sensor located proximate the generator, and for obtaining operational data including lube oil inlet temperature, speed and power; a filter system for filtering bad input data; and a misalignment analysis system that issues a misalignment warning in response to one of the BMT sensor reporting an increasing temperature and the other BMT sensor reporting a decreasing temperature.

### BACKGROUND OF THE INVENTION

The present invention relates generally to diagnosing bearing thermal anomalies in an electrical machine such as a generator, and more particularly to evaluating bearing metal temperatures (BMT) to diagnose bearing misalignment and bearing wipe issues.

Alignment changes in a generator rotor, which is a major cause of rotor vibration, leads to imbalance in the vertical loading on the bearing of the turbine and generator. This often results in babbit failure which in turn leads to bearing failure. Another cause of bearing failure is “bearing wipe,” which occurs due to a lack of sufficient oil cooling or oil flow. In many cases, the ultimate result of bearing failure is a forced outage of the generator, which is costly in terms of time and money.

### BRIEF DESCRIPTION OF THE INVENTION

Described herein are techniques for evaluating trends in bearing metal temperature (BMT) to provide early detection of bearing failure.

In one aspect of the invention, a system for identifying misalignments in a shaft of an electrical machine having a turbine and a generator is provided, comprising: an input system for obtaining bearing metal temperature (BMT) readings from a first BMT sensor located proximate the turbine and a second BMT sensor located proximate the generator, and for obtaining operational data including lube oil inlet temperature, speed and power; and a misalignment analysis system that issues a misalignment warning in response to one of the BMT sensors reporting an increasing temperature and the other BMT sensor reporting a decreasing temperature.

In another aspect of the present invention, a system for identifying bearing wipe in a bearing that supports a shaft of an electrical machine having a turbine and a generator is provided, comprising: an input system for obtaining bearing metal temperature (BMT) readings from each of a plurality of BMT sensors located proximate the generator and turbine, and for obtaining operational data including lube oil inlet temperature, speed and power; and a steady state bearing wipe analysis system that issues a bearing wipe warning in response to one of the BMT sensors reporting an increasing temperature.

In a further aspect of the present invention, a system for identifying bearing wipe in a bearing that supports a shaft of an electrical machine having a turbine and a generator is provided, comprising: an input system for obtaining bearing metal temperature (BMT) readings from each of a plurality of BMT sensors located proximate the generator and turbine, and for obtaining operational data including lube oil inlet temperature, speed and power; and a transient state bearing wipe analysis system that issues a bearing wipe warning in response to a detected spike from one of the BMT sensors during a startup or coast down of the electrical machine.

### BRIEF DESCRIPTION OF THE DRAWINGS

FIG. 1 is a simple schematic of a generator unit in accordance with an embodiment of the invention;

FIG. 2 is a schematic diagram of a computer system having a BMT analysis system according to one embodiment of the invention;

FIG. 3 shows a graph for detecting rotor misalignment according to an embodiment of the present invention;

FIG. 4 shows a graph for detecting bearing wipe according to an embodiment of the present invention; and

FIG. 5 shows a graph for detecting bearing wipe according to another embodiment of the present invention.

### DETAILED DESCRIPTION OF THE INVENTION

Various embodiments of the present invention are directed to evaluating trends in bearing metal temperature (BMT) in rotor bearings of an electrical machine to detect anomalies associated with rotor misalignment and bearing wipe issues. Technical effects of the various embodiments of the present invention include the ability to identify such issues at an early stage using BMT data, thus providing the capability of taking corrective action at a very early stage.

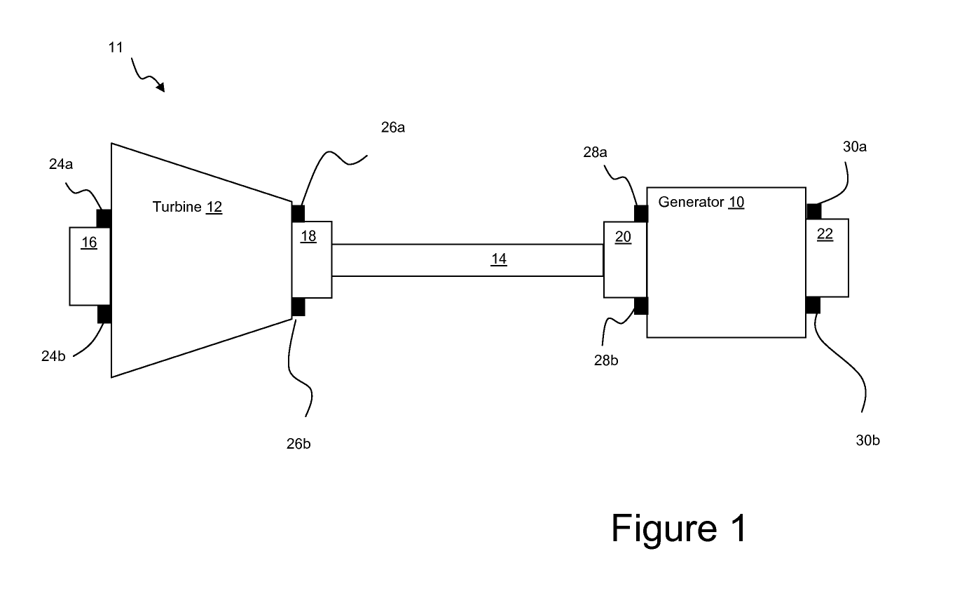

FIG. 1 depicts a simplified generator unit 11 that includes a generator 10 and a turbine 12 operationally coupled with a shaft 14. A set of rotor bearings 16, 18, 20, 22 support the shaft 14 while allowing it to rotate. Each rotor bearing 16, 18, 20, 22 includes one or more bearing temperature sensors that collect temperature data from the bearing metal. In this example, bearing 16 includes a pair of turbine collector end sensors 24a and 24b, bearing 18 includes a pair of turbine coupling end sensors 26a and 26b, bearing 20 includes a pair of generator coupling end sensors 28a and 28b, and bearing 22 includes a pair of generator collector end sensors 30a and 30b.

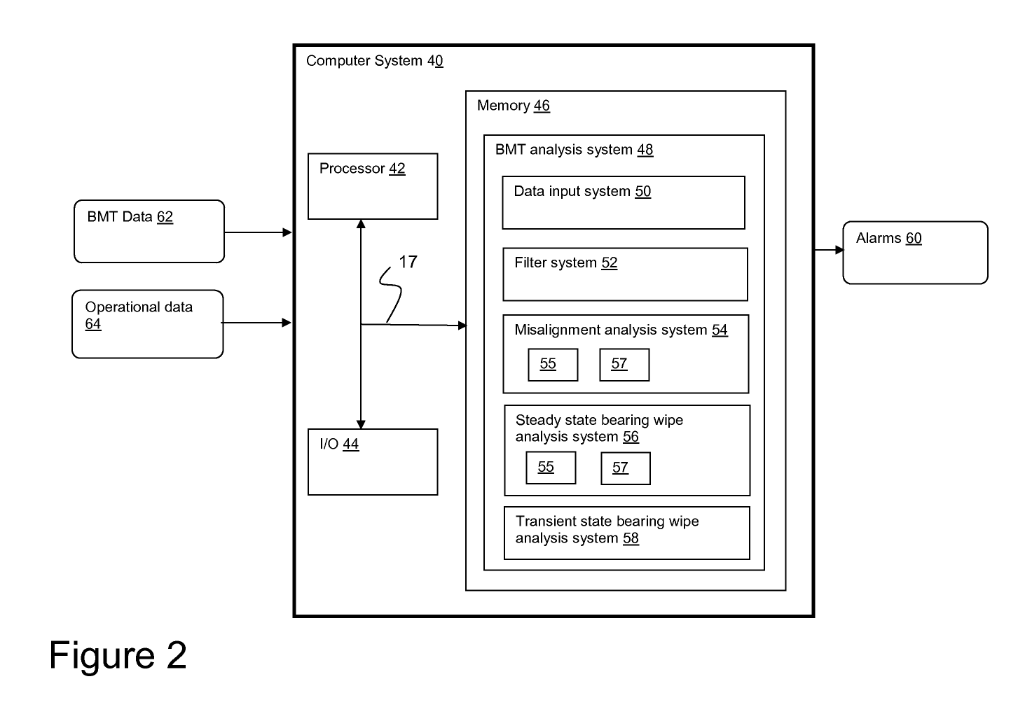

FIG. 2 depicts computer system 40 having a BMT analysis system 48 for analyzing BMT data 62 collected from the rotor bearing sensors to determine if a misalignment or bearing wipe issue exists. If an issue exists, one or more alarms 60 may be outputted. In addition to inputting BMT data 62, operational data 64 including lube oil inlet temperature, speed, and power data is also collected, e.g., from associated sensors.

In general, BMT analysis system 48 includes: a data input system 50 for reading in and managing BMT data 62 and operational data 64; a filter system 52 for identifying and discarding bad or out of range input data 62, 64; a misalignment analysis system 54 that evaluates BMT data 62 for trends indicative of a misalignment; a steady state bearing wipe analysis system 56 that evaluates BMT data 62 during steady state operations for trends indicative of bearing wipe; and a transient bearing wipe analysis system 58 that evaluates BMT data 62 during startup/shutdown operations for trends indicative of bearing wipe. Note that BMT analysis system 48 may include any one or more of the misalignment analysis system 54, steady state bearing wipe analysis system 56, and transient bearing wipe analysis system 58.

Filter system 52 may for example filter out noise, evaluate data quality, and identify bad sensors. It may also discard data that is out of range for a particular test. For instance, steady state bearing wipe analysis system 56 may only evaluate BMT data 62 when the rotor is rotating at a predefined operating speed range and power output range.

Misalignment analysis system 54 essentially detects vertical alignment changes. Whenever there is any vertical alignment change in the rotor of a generator or turbine, there is unequal loading on the bearing of the turbine and the generator at the coupling end. This leads to an increasing BMT in the generator bearing and a decreasing BMT in turbine bearing or vice versa. Over time, one of the bearings shows an increasing temperature trend and one of the bearings shows a decreasing temperature trend. This simultaneous increasing and decreasing trend of the bearing BMT is a clear indication of any misalignment in the rotor.

Since the cooling media for the bearing oil is exposed to ambient conditions, the ambient temperature can also have an effect on the BMT. Hence, to minimize the effect of ambient temperature, the monitoring parameter for the detection of misalignment may be implemented by a BMT rise calculation system 55 as the difference between BMT and the lube oil inlet temperature, referred to herein as BMT rise.

The baseline value for the turbine bearing BMT and generator bearing BMT is calculated over time by baseline calculation system 57, e.g., during a first week of collecting BMT data 62. The increase and/or decrease of BMT rise from the baseline can be monitored and evaluated to determine if there is an indication of any misalignment issues. When the BMT from a generator coupling end sensor 28a, 28b (FIG. 1) increases and the BMT from a turbine coupling end sensor 26a, 26b (FIG. 1) decreases (or vice versa) relative to their respective baselines, an alarm 60 for bearing misalignment may be issued.

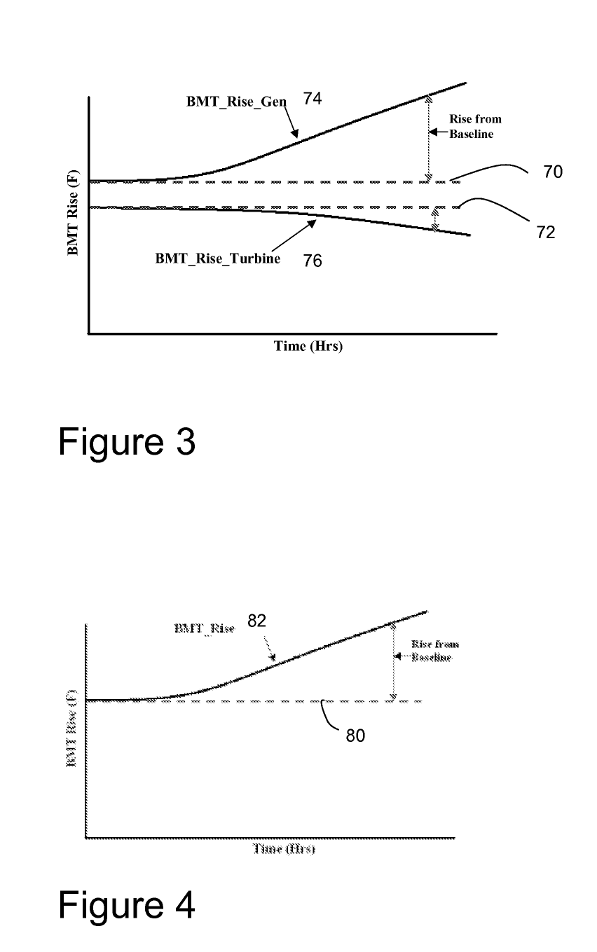

FIG. 3 depicts an illustrative example in which a generator BMT baseline 70 and turbine BMT baseline 72 are established and shown as dotted lines. The generator BMT rise 74 and turbine BMT rise 76 are monitored over time. As can be seen, the generator BMT rise 74 is increasing and the turbine BMT rise 76 is decreasing relative to their respective baselines. At some predefined set of threshold values (e.g., product of BMT rise_1 and BMT rise_2 decrease>−Y degrees F.; the BMT rise_1>P and BMT rise_2>−Q, etc.), an alarm condition can be issued indicating a misalignment. In one illustrative embodiment, misalignment analysis system 54 will issue an alarm if a BMT increase and decrease are detected and the product of the increase and decrease is greater than a threshold.

As noted with regard to FIG. 2, steady state bearing wipe analysis system 56 that evaluates BMT data 62 during steady state operations for trends indicative of a bearing wipe. The lack of sufficient flow or cooling of lube oil is one cause that can lead to bearing wipe and can increase the BMT significantly. This increasing trend of BMT in a particular bearing is captured for the detection of bearing wipe under steady state operation of the unit. Here also the monitoring parameter is the rise from a baseline and whenever the rise is above a predefined threshold, an alarm for bearing wipe can be issued. As such, steady state bearing wipe analysis system 56 likewise includes a BMT rise calculation system 55 and a baseline calculation system 57. In one illustrative embodiment, a bearing wipe problem may be identified at any of the eight sensors shown in FIG. 1.

FIG. 4 depicts an illustrative example in which a baseline 80 is established and is shown as a dotted line. BMT rise 82 from one or more sensors is tracked. When the BMT rise 82 from the baseline value exceeds a threshold, bearing wipe is indicated and an alarm can be issued.

Transient state bearing wipe analysis system 58 (FIG. 2) evaluates BMT data 62 during transient operations for trends indicative of a bearing wipe issue. When a journal becomes scored, the oil film pressure profile across the length of the bearing is chopped into segments. The consequence of this is that the journal rides closer to the babbitt surface. This is not necessarily a problem at rated speed; however, below rated speed, during coastdown or startup, the oil film thickness is reduced in proportion to the speed. As the film thickness decreases a transition from hydrodynamic to boundary layer lubrication occurs. During this transition the oil film becomes thinner and, when already reduced by the scored journal, the film may not provide sufficient support. The result is oil film breakthrough, metal-to-metal contact, and wiping of the bearing.

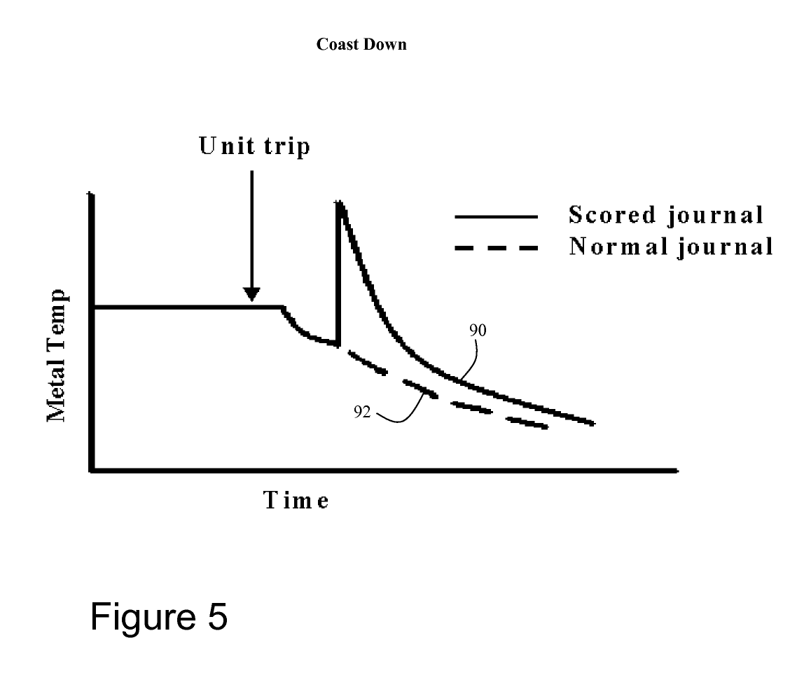

FIG. 5 depicts an illustrative example of a graph in which BMT is tracked during coastdown. As can be seen, in the case of a scored journal 90, there is a peak or spike that occurs shortly after the turbine is tripped. Conversely, in the case of a normal journal 92, no spiking occurs. Any technique may be utilized to identify a spike in the BMT data.

In various embodiments of the present invention, aspects of the systems and methods described herein can be implemented in the form of an entirely hardware embodiment, an entirely software embodiment or an embodiment containing both hardware and software elements. In one embodiment, the processing functions may be implemented in software, which includes but is not limited to firmware, resident software, microcode, etc.

Furthermore, the processing functions can take the form of a computer program product accessible from a computer-usable or computer-readable medium providing program code for use by or in connection with a computer or any instruction execution system (e.g., processing units). For the purposes of this description, a computer-usable or computer readable medium can be any computer readable storage medium that can contain or store the program for use by or in connection with the computer, instruction execution system, apparatus. Additional embodiments may be embodied on a computer readable transmission medium (or a propagation medium) that can communicate, propagate or transport the program for use by or in connection with the computer, instruction execution system, apparatus, or device.

The computer readable medium can be an electronic, magnetic, optical, electromagnetic, infrared, or semiconductor system (or apparatus or device). Examples of a computer-readable medium include a semiconductor or solid state memory, a random access memory (RAM), a read-only memory (ROM), a rigid magnetic disk and an optical disk. Current examples of optical disks include a compact disk-read only memory (CD-ROM), a compact disk-read/write (CD-R/W) and a digital video disc (DVD).

FIG. 2 depicts an illustrative computer system 40 having a processor 42, I/O 44 and memory 46 coupled together with a bus 17. Computer system 40 (FIG. 1) can comprise one or more general purpose computing articles of manufacture (e.g., computing devices) capable of executing program code installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, BMT analysis system 48 can be embodied as any combination of system software and/or application software. In any event, the technical effect of computer system 40 is to detect anomalies associated with rotor misalignment and bearing wipe issues.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the disclosure has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the disclosure.

What is claimed is:

1. A system for identifying misalignments in a shaft of an electrical machine having a turbine and a generator, comprising:
an input system for obtaining bearing metal temperature (BMT) readings from a first BMT sensor located proximate the turbine and a second BMT sensor located proximate the generator, and for obtaining operational data including lube oil inlet temperature, speed and power; and
a misalignment analysis system that issues a misalignment warning in response to one of the BMT sensors reporting an increasing temperature and the other BMT sensor reporting a decreasing temperature.

2. The system of claim 1, wherein the misalignment analysis system further includes a system for calculating a BMT rise for each BMT sensor, BMT rise calculated as a difference between a BMT and the lube oil inlet temperature.

3. The system of claim 2, wherein the misalignment analysis system further includes a system for calculating a baseline BMT based on an initial set of BMT rise values.

4. The system of claim 3, wherein the increasing and decreasing temperature for a BMT sensor are based on a difference between a reported BMT and the baseline BMT.

5. The system of claim 1, further comprising a filter system for filtering bad input data.

6. The system of claim 5, wherein the filter system filters non-steady state data by evaluating the operational data.

7. The system of claim 1, wherein the first BMT sensor is located at a coupling end of the turbine and the second BMT sensor is located at a coupling end of the generator.

8. A system for identifying bearing wipe in a bearing that supports a shaft of an electrical machine having a turbine and a generator, comprising:
an input system for obtaining bearing metal temperature (BMT) readings from each of a plurality of BMT sensors located proximate the generator and turbine, and for obtaining operational data including lube oil inlet temperature, speed and power; and
a steady state bearing wipe analysis system that issues a bearing wipe warning in response to one of the BMT sensors reporting an increasing temperature.

9. The system of claim 8, wherein the steady state bearing wipe analysis system further includes a system for calculating a BMT rise for each BMT sensor, the BMT rise calculated as a difference between a BMT and the lube oil inlet temperature.

10. The system of claim 9, wherein the steady state bearing wipe analysis system further includes a system for calculating a baseline BMT based on an initial set of BMT rise values.

11. The system of claim 10, wherein the increasing temperature for a BMT sensor is based on a difference between a reported BMT and the baseline BMT.

12. The system of claim 8, further comprising a filter system for filtering bad input data.

13. The system of claim 12, wherein the filter system filters non-steady state data by evaluating the operational data.

14. The system of claim 8, wherein the plurality of BMT sensors are located at a coupling end of the turbine, a collector end of the turbine, a coupling end of the generator and a collector end of the turbine.

15. A system for identifying bearing wipe in a bearing that supports a shaft of an electrical machine having a turbine and a generator, comprising:
an input system for obtaining bearing metal temperature (BMT) readings from each of a plurality of BMT sensors located proximate the generator and turbine, and for obtaining operational data including lube oil inlet temperature, speed and power; and
a transient state bearing wipe analysis system that issues a bearing wipe warning in response to a detected spike from one of the BMT sensors during a startup or coast down of the electrical machine.

16. The system of claim 15, wherein the plurality of BMT sensors are located at a coupling end of the turbine, a collector end of the turbine, a coupling end of the generator, and a collector end of the turbine.

17. The system of claim 15, further comprising a filter system for filtering bad input data.
